(19) United States
(12) Patent Application Publication
(10) Pub. No.: US 2011/0304578 A1
(43) Pub. Date: Dec. 15, 2011

(54) TOUCH PANEL

(75) Inventors: Hyun Jun KIM, Suwon (KR); Kyoung Ho LEE, Hwaseong-si (KR); Kyoung Soo CHAE, Suwon (KR); Jong Young LEE, Suwon (KR)

(73) Assignee: SAMSUNG ELECTRO-MECHANICS CO., LTD., Suwon (KR)

(21) Appl. No.: 12/873,143

(22) Filed: Aug. 31, 2010

(30) Foreign Application Priority Data
Jun. 9, 2010 (KR) 10-2010-0054403

(51) Int. Cl. G06F 3/045

(52) U.S. Cl. 345/174; 345/176

(57) ABSTRACT

Disclosed herein is a touch panel 100 including: a transparent substrate 10, first electrode patterns 20 that are formed on one surface of the transparent substrate 10 and include a plurality of first sensing units 23 and connecting units 25 connecting adjacent first sensing units 23, and second electrode patterns 30 that are formed on one surface of the transparent substrate 10 vertically with the first electrode patterns 20 and include a plurality of second sensing units 33 and bridges 35 connecting the adjacent second sensing units 33 to be spaced apart from the connecting units 25, wherein the bridge 35 is divided to form two or more bridge patterns 37. The bridge is divided to form two or more bridge patterns so that a user cannot recognize the bridge, thereby making it possible to improve visibility of the touch panel.

### CROSS REFERENCE TO RELATED APPLICATION

This application claims the benefit of Korean Patent Application No. 10-2010-0054403, filed on Jun. 9, 2010, entitled “Touch Panel”, which is hereby incorporated by reference in its entirety into this application.

### BACKGROUND OF THE INVENTION

1. Technical Field

The present invention relates to a touch panel.

2. Description of the Related Art

Alongside the growth of computers using digital technology, devices assisting the computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse as being currently responsible for the input device function. Thus, the demand for a device that is simple, does not malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode my tube (CRT), so that a user selects the information desired while viewing the image display device.

The touch panel is classifiable as a resistive type, a capacitive type, an electromagnetic type, a surface acoustic wave (SAW) type, and an infrared type. Among others, the capacitive touch panel having excellent durability, rapid response time and capable of multi-touch is currently in the spotlight.

The capacitive touch panel is largely divided into a self capacitive touch panel and a mutual capacitive touch panel.

First, in the self capacitive touch panel, a plurality of electrode patterns are formed on a substrate in order to recognize a touch and electrode wirings are connected to each of the electrode patterns, thereby measuring change in capacitance. Even though the self capacitive touch panel has a simple driving scheme, it has a complicated structure in that a plurality of electrode patterns should be separately formed and the electrode wirings should be connected to each of the electrode patterns, such that a manufacturing process thereof is complicated.

Meanwhile, the mutual capacitive touch panel forms two kinds of electrode patterns, wherein one is formed in an X-axis direction and the other is formed in a Y-axis direction, which forms a lattice structure and then measures capacitance formed between the two kinds of electrode patterns, thereby calculating coordinates of a touched point. The mutual capacitive touch panel is classified into a two-layer structure and a single-layer structure. The mutual capacitive touch panel having a two-layer structure disposes two kinds of electrode patterns on different planes, such that the thickness thereof increases.

To the contrary, the mutual capacitive touch panel having a single-layer structure disposes two kinds of electrode patterns on the same plane. In the mutual capacitive touch panel having a single-layer structure, two kinds of electrode patterns should not be electrically connected so that a bridge structure should be provided at an intersection point. Herein, the bridge structure implies a structure in which one of the two kinds of electrode patterns is positioned on a lower side and the other thereof is connected to an upper side through a bridge, having an insulating layer therebetween.

However, the bridge of the touch panel according to the prior art is formed to have a predetermined width or more so that it may be recognized by a user, thereby degrading visibility of the touch panel. In order to solve this problem, a method of narrowing the width of the bridge may be considered. However, if the width of the bridge is narrowed, terminal resistance of the bridge abruptly increases to degrade the performance of the touch panel. In addition, parasitic capacitance is generated between the bridge and electrode patterns under the bridge to operate as noise in recognizing the touch.

### SUMMARY OF THE INVENTION

The present invention has been made in an effort to provide a touch panel that forms two or more bridge patterns and connection patterns by dividing a bridge and a connecting unit to improve visibility of the touch panel and prevent terminal resistance of the bridge and the connecting unit from abruptly increasing.

A touch panel according to a preferred embodiment of the present invention includes: a transparent substrate; first electrode patterns that are formed on one surface of the transparent substrate and include a plurality of first sensing units and connecting units connecting the adjacent first sensing units; and second electrode patterns that are formed on one surface of the transparent substrate vertically with the first electrode patterns and include a plurality of second sensing units and bridges connecting the adjacent second sensing units to be spaced apart from the connecting units, wherein the bridge is divided to form two or more bridge patterns.

Herein, the connecting unit is divided to form two or more connection patterns.

Further, the bridge is formed of three or four bridge patterns.

Further, the connecting unit is formed of three or four connection patterns.

Further, when the terminal resistance of the one bridge pattern is MΩ, the terminal resistance of the bridge formed of the N bridge patterns is smaller than M/N Ω.

Further, when the terminal resistance of the one connection pattern is M Ω, the terminal resistance of the connecting unit formed of the N connection patterns is smaller than M/N Ω.

Further, the sum of the widths of two or more bridge patterns forming the bridge is 0.8 mm to 1.6 mm.

Further, the sum of the widths of two or more connection patterns forming the connecting unit is 0.8 mm to 1.6 mm.

Further, the first sensing unit and the second sensing unit are formed to have a diamond shape, a quadrangular shape, an octagonal shape, or a circular shape.

### BRIEF DESCRIPTION OF THE DRAWINGS

FIG. 1 is a perspective view of a touch panel according to a first preferred embodiment of the present invention;

FIG. 2 is an enlarged plan view of portion A of FIG. 1;

FIG. 3 is a plan view showing a modified example of the bridge pattern of FIG. 2;

FIGS. 4 to 6 are plan views showing modified examples of the first sensing unit and the second sensing unit of FIG. 2;

FIG. 7 is a perspective view of a touch panel according to a second preferred embodiment of the present invention;

FIG. 8 is an enlarged plan view of portion B of FIG. 7;

FIG. 9 is a plan view showing a modified example of the bridge pattern and the connection pattern of FIG. 8; and

FIGS. 10 to 12 are plan views showing modified examples of the first sensing unit and the second sensing unit of FIG. 8.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

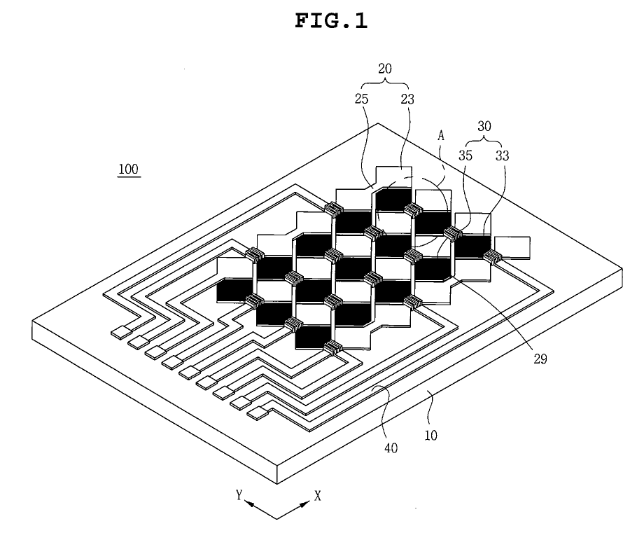

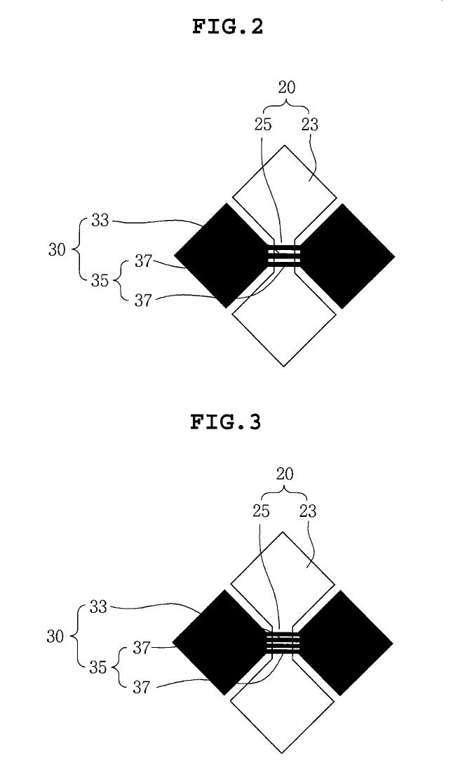

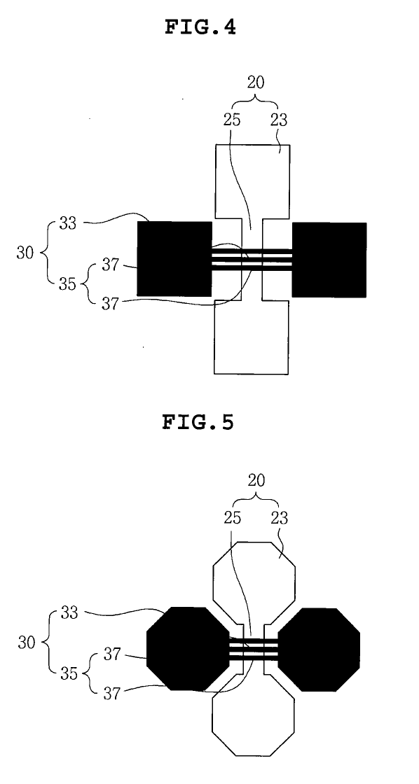

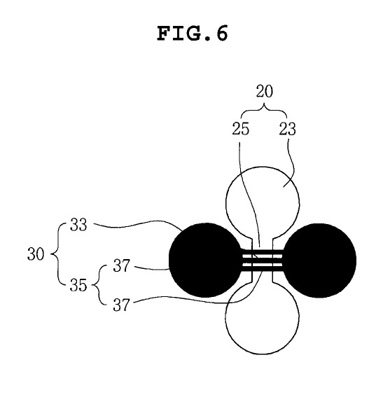

FIG. 1 is a perspective view of a touch panel according to a first preferred embodiment of the present invention, FIG. 2 is an enlarged plan view of portion A of FIG. 1, FIG. 3 is a plan view showing a modified example of the bridge pattern of FIG. 2, and FIGS. 4 to 6 are plan views showing modified examples of the first sensing unit and the second sensing unit of FIG. 2.

As shown in FIGS. 1 and 2, a touch panel 100 according to the present embodiment is configured to include a transparent substrate 10, first electrode patterns 20 that are formed on one surface of the transparent substrate 10 and include a plurality of first sensing units 23 and connecting units 25 connecting the adjacent first sensing units 23, and second electrode patterns 30 that are formed on one surface of the transparent substrate 10 vertically with the first electrode patterns 20 and include a plurality of second sensing units 33 and bridges 35 connecting the adjacent second sensing units 33 to be spaced apart from the connecting units 25, wherein the bridge 35 is divided to form two or more bridge patterns 37.

The transparent substrate 10 serves to provide a space on which the first electrode patterns 20 and the second electrode patterns 30 are formed. Herein, the material of the transparent substrate 10 is not particularly limited as long as it has transparency and support force of a predetermined strength or more, and may include polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; containing K resin), glass or tempered glass and so on.

The first electrode pattern 20 serves to generate a signal when a user touches the panel, together with the second electrode pattern 30, to allow a controller to recognize touched coordinates. At this time, the first electrode patterns 20 and the second electrode patterns 30 are formed on one surface of the transparent substrate 10 vertically to each other. For example, the first electrode patterns 20 are formed to be in parallel in an X-axis direction and the second electrode patterns 30 are formed to be in parallel in a Y-axis direction. This is just exemplary, however, the first electrode patterns 20 may also be formed to be in parallel in a Y-axis direction and the second electrode patterns 30 may also be formed to be in parallel in an X-axis direction. In addition, the first electrode pattern 20 may be made of a conductive polymer having excellent flexibility and a simple coating process as well as indium tin oxide (ITO) that is commonly used. Herein, the conductive polymer includes poly-3,4-ethylenedioxythiophene/polystyrenesulfonate (PEDOT/PSS), polyaniline, polyacetylene, polyphenylenevinylene, or the like.

Meanwhile, the first electrode pattern 20 is configured to include the first sensing unit 23 and the connecting unit 25. Herein, the first sensing unit 23 serves to sense a user's touch and the connecting unit 25 is formed at a point intersected with the bridge 35 of the second electrode pattern 30 to connect the adjacent first sensing units 23 in an X-axis direction. In addition, the first sensing unit 23 may be formed to have a diamond shape (see FIG. 2), a quadrangular shape (see FIG. 4), an octagonal shape (see FIG. 5), or a circular shape (see FIG. 6), but is not always limited thereto.

As described above, the second electrode pattern 30 serves to generate a signal at the time of user's touch, together with the first electrode pattern 20, and is formed on one surface of the transparent substrate 10 in a Y direction, being vertical to the first electrode pattern 20. In addition, the second electrode pattern 30 may also be made of ITO or a conductive polymer, similar to the first electrode pattern 20.

Meanwhile, the second electrode pattern 30 is configured to include the second sensing unit 33 and the bridge 35. Herein, the second sensing unit 33 senses a user's touch and the bridge 35 is formed at a point intersected with the connecting unit 25 of the first electrode pattern 20 to connect the adjacent second sensing units 33 in a Y-axis direction. At this time, it is preferable that an insulating layer 29 is interposed between the bridge 35 and the connecting unit 25 in order to prevent the bridge 35 and the connecting unit 25 from being electrically conductive with each other (however, in FIGS. 2 to 6 the insulating layer 29 is omitted in order to clearly show the connecting unit 25). In addition, the second sensing unit 33 may be formed to have a diamond shape (see FIG. 2), a quadrangular shape (see FIG. 4), an octagonal shape (see FIG. 5), or a circular shape (see FIG. 6), similar to the first sensing unit 23, but is not always limited thereto.

In the present embodiment, the bridge 35 is divided to form two or more bridge patterns 37 (see FIGS. 2 to 6) in order to improve visibility of the touch panel 100 and reduce parasitic capacitance between the bridge 35 and the connecting unit 25. Herein, even though the number of bridge patterns 37 is not particularly limited, three (see FIG. 2) or four (see FIG. 3) bridge patterns are preferable in order to ensure visibility of the touch panel 100 and prevent the manufacturing process thereof from being complicated.

In addition, when the bridge pattern 37 has a too wide width, it may degrade visibility of the touch panel 100, and when the bridge pattern 37 has a too narrow width, the terminal resistance of the bridge 35 increases to degrade the performance of the touch panel 100. Therefore, in consideration of the visibility of the touch panel 100 and the terminal resistance of the bridge 35, it is preferable that the sum of the widths of two or more bridge patterns 37 forming the single bridge 35 is 0.8 mm to 1.6 mm.

Meanwhile, when the terminal resistance of the bridge pattern 37 is M Ω, the terminal resistance of the bridge 35 formed of N bridge patterns 37 is to mathematically be M/N Ω (□ N bridge patterns 37 are connected in parallel). However, the terminal resistance of the bridge 35 is not substantially M/N Ω, and the actually measured value of the terminal resistance of the bridge 35 related thereto is as shown in Table 1 below.

TABLE 1

| Terminal resistance | Number of | Terminal resistance |
|---|---|---|
| (Ω) of bridge pattern | bridge patterns | (Ω) of bridge |
| 2706.57 | 3 | 901.76 |
| 2706.57 | 4 | 674.25 |
| 3002.84 | 3 | 999.67 |
| 3002.84 | 4 | 749.15 |

As shown in FIG. 1, when the terminal resistance of the bridge pattern 37 is 2706.57Ω, the terminal resistance of the bridge 35 formed of three bridge patterns 37, that is, 901.76Ω, is smaller than the terminal resistance of the bridge 35 that is to be mathematically deduced, that is, 902.19Ω (2706.57 Ω/3). In addition, the terminal resistance of the bridge 35 formed of four bridge patterns 37, that is, 674.25Ω, is also smaller than the terminal resistance of the bridge 35 that is to be mathematically deduced, that is, 676.64Ω (2706.57 Ω/4).

When the terminal resistance of the bridge pattern 37 is 3002.84Ω, the terminal resistance of the bridge 35 formed of three bridge patterns 37, that is, 999.67Ω, is also smaller than the terminal resistance of the bridge 35 that is to be mathematically deduced, that is, 1000.95Ω (3002.84 Ω/3). In addition, the terminal resistance of the bridge 35 formed of four bridge patterns 37, that is, 749.15Ω, is also smaller than the terminal resistance of the bridge 35 that is to be mathematically deduced, that is, 750.71Ω (3002.84 Ω/4).

In consideration of the value of the terminal resistance of the bridge 35 as described above, when the bridge 35 is formed of two or more bridge patterns 37, the actually measured value of the terminal resistance of the bridge 35 is smaller than the mathematically estimated value thereof. Therefore, the touch panel 100 according to the present embodiment divides the bridge 35 to have a relatively small increase in the terminal resistance of the bridge 35, while improving visibility of the touch panel 100, thereby not affecting the performance of the touch panel 100.

Meanwhile, the electrode wirings 40 (see FIG. 1) receiving electrical signals from the first electrode pattern 20 and the second electrode pattern 30 are formed on one end of the first electrode pattern 20 and one end of the second electrode pattern 30. At this time, the electrode wiring 40 may be printed using a silk screen method, a gravure printing method, an ink-jet printing method or the like. Further, the electrode wiring 40 may be made of silver (Ag) paste or organic Ag having superior electrical conductivity, but the present invention is not limited thereto. In addition, a conductive polymer, carbon black (including CNT), or a low resistive metal including metal or a metal oxide such as ITO may be used. Meanwhile, even though the electrode wirings are shown to be connected to one end of the first electrode pattern 20 and one end of the second electrode pattern 30, this is just exemplary and they may also be connected to only both ends of the first electrode pattern 20 and both ends of the second electrode pattern 30 according to the type of the touch panel.

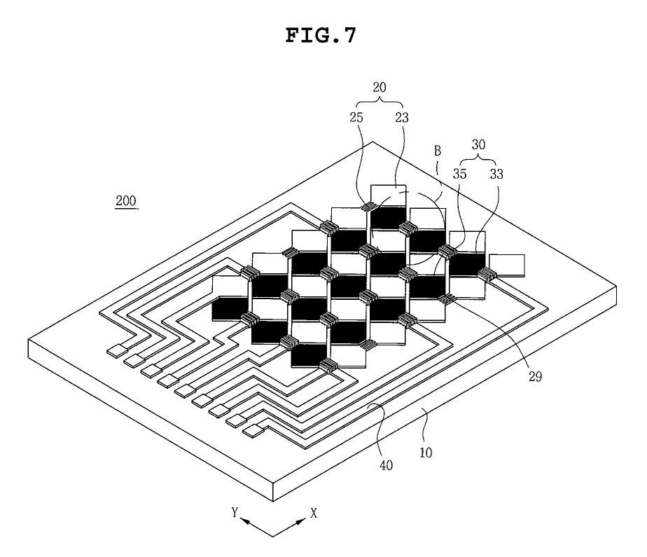

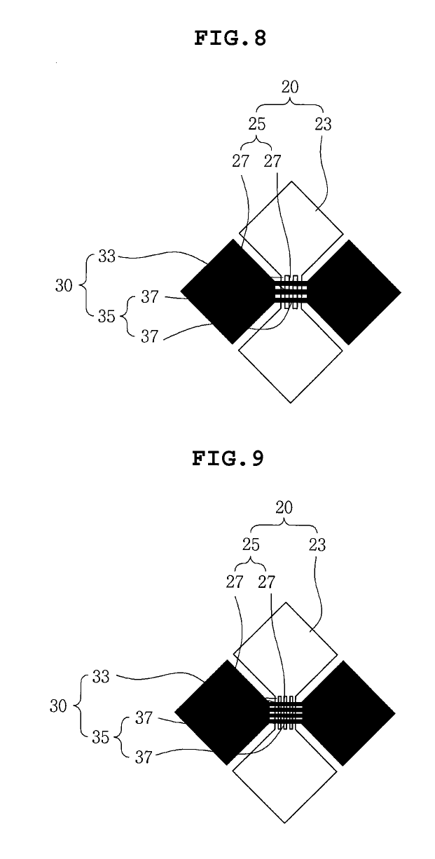

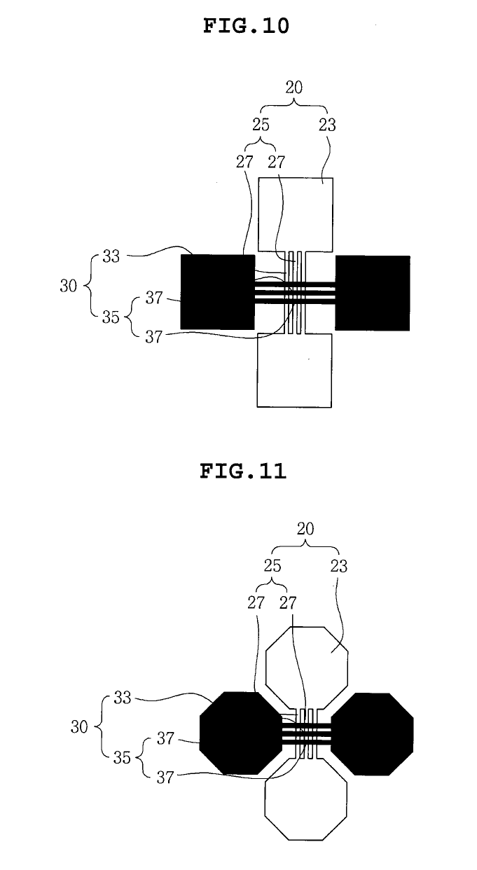

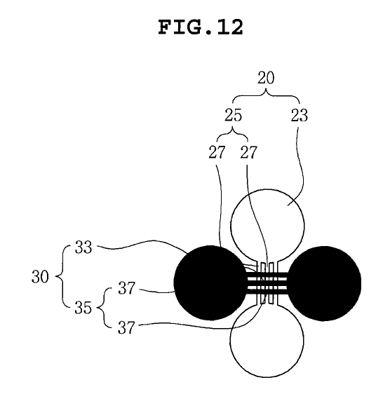

FIG. 7 is a perspective view of a touch panel according to a second preferred embodiment of the present invention, FIG. 8 is an enlarged plan view of portion B of FIG. 7, FIG. 9 is a plan view showing a modified example of the bridge pattern and the connection pattern of FIG. 8, and FIGS. 10 to 12 are plan views showing modified examples of the first sensing unit and the second sensing unit of FIG. 8.

As shown in FIGS. 7 to 8, the most significant difference between a touch panel 200 according to the present embodiment and the touch panel 100 according to the first embodiment is whether the connecting unit 25 is divided or not. Therefore, the present embodiment will be described based on the division of the connecting unit 25 and a description overlapping with the first embodiment will be omitted.

The connecting unit 25 of the touch panel 200 according to the present embodiment is divided to form two or more connection patterns 27 (see FIGS. 8 to 12). Herein, even though the number of connection patterns 27 is not particularly limited, three (see FIG. 8) or four (see FIG. 9) connection patterns are preferable in order to ensure visibility of the touch panel 200 and prevent the manufacturing process thereof from being complicated.

In consideration of the visibility of the touch panel 200 and the terminal resistance of the connecting unit 25, it is preferable that the sum of the widths of two or more connection patterns 27 forming the single connecting unit 25 is 0.8 mm to 1.6 mm, similar to the bridge pattern 37.

Meanwhile, when the terminal resistance of the connection pattern 27 is M Ω, the terminal resistance of the connecting unit 25 formed of N connection patterns 27 is to mathematically be M/N Ω(□ N connection patterns 27 are connected in parallel). However, the actual terminal resistance of the connecting unit 25 is smaller than MIN Ω, similar to the terminal resistance of the bridge 35. Therefore, the touch panel 200 according to the present embodiment divides the connecting unit 25 to have a relatively small increase in the terminal resistance of the connecting unit 25, while improving visibility of the touch panel 200, thereby not affecting the performance of the touch panel 200.

In addition, in the present embodiment, the first sensing unit 23 and the second sensing unit 33 may be formed to have a diamond shape (see FIG. 8), a quadrangular shape (see FIG. 10), an octagonal shape (see FIG. 11), or a circular shape (see FIG. 12), but are not always limited thereto.

The touch panel 200 according to the present embodiment divides not only the bridge 35 but also the connecting unit 25 to form two or more connection patterns 27, thereby making it possible to more improve visibility of the touch panel 200 and more effectively reduce parasitic capacitance between the bridge 35 and the connecting unit 25.

According to the present invention, the bridge and the connecting unit are divided to form two or more bridge patterns and connection patterns so that a user cannot recognize the bridge and the connecting unit, thereby making it possible to improve visibility of the touch panel.

In addition, according to the present invention, the bridge and the connecting unit are divided to have a small increase in the terminal resistance of the bridge and the terminal resistance of the connecting unit as compared to the case in which the width of the bride and the width of the connecting unit are manufactured to be narrow.

In addition, according to the present invention, the bridge and the connecting unit are divided to reduce parasitic capacitance generated between the bridge and the connecting unit, thereby making it possible to reduce noise when recognizing a touch.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch panel, comprising:
a transparent substrate;
first electrode patterns that are formed on one surface of the transparent substrate and include a plurality of first sensing units and connecting units connecting the adjacent first sensing units; and
second electrode patterns that are formed on one surface of the transparent substrate vertically with the first electrode patterns and include a plurality of second sensing units and bridges connecting the adjacent second sensing units to be spaced apart from the connecting units,
wherein the bridge is divided to form two or more bridge patterns.

2. The touch panel as set forth in claim 1, wherein the connecting unit is divided to form two or more connection patterns.

3. The touch panel as set forth in claim 1, wherein the bridge is formed of three or four bridge patterns.

4. The touch panel as set forth in claim 2, wherein the connecting unit is formed of three or four connection patterns.

5. The touch panel as set forth in claim 1, wherein when the terminal resistance of the one bridge pattern is M Ω, the terminal resistance of the bridge formed of the N bridge patterns is smaller than M/N Ω.

6. The touch panel as set forth in claim 2, wherein when the terminal resistance of the one connection pattern is M Ω, the terminal resistance of the connecting unit formed of the N connection patterns is smaller than M/N Ω.

7. The touch panel as set forth in claim 1, wherein the sum of the widths of two or more bridge patterns forming the bridge is 0.8 mm to 1.6 mm.

8. The touch panel as set forth in claim 2, wherein the sum of the widths of two or more connection patterns forming the connecting unit is 0.8 mm to 1.6 mm.

9. The touch panel as set forth in claim 1, wherein the first sensing unit and the second sensing unit are formed to have a diamond shape, a quadrangular shape, an octagonal shape, or a circular shape.

10. The touch panel as set forth in claim 2, wherein the first sensing unit and the second sensing unit are formed to have a diamond shape, a quadrangular shape, an octagonal shape, or a circular shape.
